(19) United States
(12) Patent Application Publication
(10) Pub. No.: US 2026/0093540 A1
(43) Pub. Date: Apr. 2, 2026

(54) LOCALITY-AWARE TOKEN MANAGEMENT FOR A DISTRIBUTED FILE SYSTEM

(71) Applicant: International Business Machines Corporation, Armonk, NY (US)

(72) Inventors: Robert Lindsay Todd, Sand Lake, NY (US); Wayne A. Sawdon, San Jose, CA (US); Tram Thi Mai Nguyen, Santa Clara, CA (US)

(21) Appl. No.: 18/904,194

(22) Filed: Oct. 2, 2024

(51) Int. Cl. G06F 9/50

(52) U.S. Cl. CPC G06F 9/5027

(57) ABSTRACT

Mechanisms are provided for controlling access to computing resources. The mechanisms receive, at a first local token manager, a request for a token to access a computing resource from a local node associated with the first local token manager. The mechanisms determine, at the first local token manager, if the token is present in a local token cache of the first local token manager. The mechanisms, in response to the token being present in the local token cache, grant by the first local token manager, the token to the local node. The mechanisms, in response to the token not being present in the local token cache, request the token from a global token manager. The mechanisms, in response to receiving the token from the global token manager, cache the token in the local token cache of the first local token manager and granting the token to the local node.

### BACKGROUND

The present application relates generally to data processing and more specifically to a computing tool and computing tool operations/functionality for providing locality-aware token management for a distributed file system.

Portable Operating System Interface (POSIX) is a family of standards specified by the Institute of Electrical and Electronics Engineers (IEEE) Computer Society for maintaining compatibility between operating systems. POSIX defines both the system and user-level application programming interfaces (APIs) along with command line shells and utility interfaces for software compatibility (portability) with variants of Unix and other operating systems. POSIX-compliant file systems offer the strongest form of data consistency, often referred to as “strict consistency.” Strict consistency requires that all operations on the file system appear to be atomic and are executed in a globally known order.

Such strict consistency ensures that any read to the file system always returns the most recently written data. Providing this guarantee in a distributed file system requires data written on one node to be immediately available on all nodes in the cluster. This is typically accomplished by a locking or token mechanism that ensures only one node can write to a portion of the file system at a time. The “portion”might be a directory, a file, or a byte range within a file.

Each portion has a unique identifier (id) that is generated from the file id and offset within the file. Whenever a node or processor wishes to write data to this portion, the node must first obtain a “token” granting it permission to write. In a like manner, to read a portion of the file system, the node must also obtain a token granting it permission to read. Thus, the tokens ensure strict consistency on all cacheable portions of the file system.

A “token manager” is the software construct that manages “tokens.” It grants tokens to nodes and tracks which nodes hold which tokens. This allows the token manager to identify requests for tokens that conflict with outstanding tokens, then revoke the token from the current node holding it in order to grant the token to the requesting node. The ordering of the token requests determines the sequence of updates to insure strict consistency.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, in a data processing system, a method is provided for controlling access to computing resources. The method comprises receiving, at a first local token manager, a request for a token to access a computing resource from a local node associated with the first local token manager. The method further comprises determining, at the first local token manager, if the token is present in a local token cache of the first local token manager. In addition, the method comprises, in response to the token being present in the local token cache, granting, by the first local token manager, the token to the local node. Moreover, the method comprises, in response to the token not being present in the local token cache, requesting the token from a global token manager. Furthermore, the method comprises, in response to receiving the token from the global token manager, caching the token in the local token cache of the first local token manager and granting the token to the local node.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The present disclosure, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of a locality-aware token manager in accordance with one illustrative embodiment;

FIG. 3 is an example diagram illustrating an example locality-aware token request processing operation in accordance with one illustrative embodiment;

FIG. 4 is an example diagram illustrating an example locality-aware token revocation operation in accordance with one illustrative embodiment;

FIG. 5 is a flowchart outlining an example locality-aware token request processing operation in accordance with one illustrative embodiment; and FIG. 6 is a flowchart outlining an example locality-aware token revocation operation in accordance with one illustrative embodiment.

### DETAILED DESCRIPTION

The illustrative embodiments provide an improved computing tool and improved computing tool operations/functionality for locality-aware token management for distributed file systems. As noted above, POSIX-compliant distributed file systems ensure strict consistency by providing locking tokens to ensure that only one entity can write to portions of the file system at any particular time and that all entities will read the most recently written data. The token manager manages the tokens and controls the granting and recovering of tokens to enforce the strict consistency. For small computing systems, a single centralized token manager assigned to a single node will manage all of the tokens in a computing system which may span multiple clusters of nodes. In other words, each node may be a virtual or physical machine, and a cluster may be a logical combination of nodes that are affiliated with one another and operate with each other. For example, a distributed computing system may be a cluster, i.e., a group of systems (nodes) that perform a common task, share a distributed file system, and maintain some shared state so as to know what other nodes were configured to be part of the cluster. There are protocols for new nodes to join a cluster and for existing nodes to leave a cluster so that all nodes know all members of the cluster.

For large computing systems, a single centralized token manager will not be sufficient to track all the tokens and respond to requests quickly enough to be a feasible solution. To the contrary, for larger computing systems having a distributed file system environment, the token manager function should be spread across a plurality of nodes. Many factors go into deciding how many token managers are needed, including the number depending on the number of nodes in the cluster, how fast the hardware implementing the token managers is, the speed of the network, etc. Whenever token managers cannot keep up with the load of token management being required of each of them, more should be added. That is, in a distributed large scale computing system involving many computing devices and data networks potentially spread across large geographic areas, many different token managers will likely be needed. Regardless of the cluster size, each token has a unique token manager and each token manager manages a disjoint set of tokens. Because each token has a unique identifier (id), a function may be performed on the token id to “shard” the set of tokens across the set of token managers. Sharding is a database partitioning technique that splits the database into relatively small partitions, or “shards,” that have their own data that is independent of other shards. In the case of the illustrative embodiments, these shards are sets of tokens with each node hosting a token manager having a shard corresponding to a disjoint subset of all outstanding tokens.

To improve availability and protect from disaster, it is desirable to spread the cluster and file system across more than one site or availability zone, such as over multiple data centers in different geographic locations. A site refers to a location where a data center resides. A cluster (i.e., a group of nodes that share a filesystem) can consist of one or more sites. This allows continued operation even if an entire site or data center has an outage. Consequently, some nodes in the cluster will be local and offer low latency communication whereas other nodes will be remote with much higher latency, e.g., a factor of 10,000× slower. Furthermore, bandwidth to a remote location is substantially less than local communication, further increasing the latency penalty.

When a cluster is spread across sites, the file system data is replicated to each location. Because data reads greatly outnumber data writes, the performance of the cluster is optimized by always reading the local replica of the data. This requires the less frequent writes to always update all replicas. Unfortunately, with strict consistency mechanisms, even though the data is replicated to all sites, a node wishing to access the data must first obtain a token. Because the tokens are sharded across token managers at all locations, the local client may still have to communicate to a remote token manager, even if it is only reading the local copy of the file. Frequent communication to remote nodes incurs a penalty with a direct impact on application performance.

The illustrative embodiments provide a computing tool and computing tool operations/functionality to address the issues noted above with regard to tokens and token management in distributed file systems. In accordance with one or more of the illustrative embodiments, improved computing tool operations/functionality are provided which maintain strict consistency in a distributed cluster yet minimize remote node communication for token management. The one or more illustrative embodiments provide one or more locality-aware token managers which allow the token managers to form hierarchies. Client nodes communicate with the nearby token managers and rely on them to communicate with remote managers to maintain a consistent cache of all tokens held at the local site. Locality-aware token managers not only improve application performance, but they also improve token manager recovery and reconfiguration times by limiting the impact to only the local nodes. This allows remote nodes to continue normal operation unimpeded.

The first step to becoming locality-aware is to ensure that every node has the ability to determine its location and the set of nodes that are local to it. There are many ways this could be accomplished such as via a static configuration, considering network addresses (e.g., identifying nodes that are local to one another via subnet identifiers in network addresses), or dynamically by measuring the latency between each node (e.g., pinging nodes to determine latency such that latencies of milliseconds indicate nodes that are less local to one another than latencies of microseconds and sharing latencies with other nodes so each can consistently determine its local group of nodes).

Once the set of local nodes is known, they must agree on a “local shard” function which determines which shards in the complete set of token ids are to be sent to the token managers; the shard sent to a token manager has only token ids of portions of the distributed file system that are local to that token manager.

Local nodes only communicate with local token managers. Each local token manager now serves as a gateway to tokens that are not yet cached locally. New tokens are obtained by a local token manager by using a different shard function called a “global shard” function. The global shard is across all nodes in the cluster and, thus, the global token manager may be considered remote with regard to the nodes. The local token manager requests the token from the global token manager and indicates that it is only caching the token, that it is not the actual client node.

The global token manager checks if the token is in use and, if not, it will grant both read and write access to the data. If the token is in use for read-only access, then it can be granted to the local token manager as a read-only token. The global token manager records granting the token to the local token manager and marks it to indicate a cache-only token. The local token manager can now grant the token to the original requestor.

As tokens accumulate at the local token manager, it has the ability to grant consistent tokens to any local node. If the local token manager has read-write access, the local token manager can revoke tokens and grant tokens to other nodes in the local cluster without involving the global token manager. Likewise, if the local token manager has read-only access, the local token manager can grant read-only access to any local node without involving the global token manager.

Token conflicts require the tokens to be revoked from the nodes currently holding tokens conflicting with the request. If the revoke comes to the local token manager from a global token manager, the local token manager will simply propagate the revocation to the local nodes holding conflicting tokens. In a like manner, if a local node requests a conflicting token, the local token manager passes the revoke to the remote token manager, relaying through a global token manager if direct communication is not possible, and waits for its reply before granting the token locally.

A “cache-only” token bit in the actual token structure is used to manage the token and is used by the global token manager for recovery. When a node fails, the global token manager detects the failure through known cluster membership protocols and frees all tokens held by that node. If a local token manager fails, the surviving nodes use a consensus algorithm to elect a new node to become the local token manager and inform it of all tokens currently held. For example, a consensus algorithm may be based on the node that has the fastest response to ping, the nearest neighbor (within the same rack), or on some static priority assigned to each node. The elected node must be local and all local nodes must be informed.

In accordance with one or more of the illustrative embodiments, for locality-aware token managers, it is important to know which recovery method should be applied for each token. If the “cache-only” token bit is not set in the tokens, then the tokens belonging to the failed node are freed. If the “cache-only” token bit is set, then the global token manager waits for local token manager recovery to complete. It does not free the tokens but reassigns the token ownership to the new local token manager. In a like manner, if the number of local token managers changes (for example, by adding or deleting local token managers), the tokens can be shuffled between the local token managers without involving the global token managers. If a global token manager attempts to revoke a locally held token, it must wait for the local shuffling to complete, but all other token managers remain unaffected.

The above describes a two-level hierarchy with local and remote nodes and token managers. Embodiments of the present disclosure can include more hierarchy levels by utilizing a different shard function at each level to map the token ids to different subsets of nodes. This allows fine grain partitioning of the token space (for example, all nodes in a single rack) to better parallelize token management and limit its impact under failures. The location aware protocol also supports singleton nodes which have no local neighbors by simply having these nodes use the global shard function for all tokens.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc. attributable to and/or performed by the engine. Instead, it is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is for purposes of convenience of reference and not intended to be limiting to a specific implementation unless otherwise specified. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, or computer program product, it should be appreciated that the illustrative embodiments described herein are specifically directed to an improved computing tool and the methodology implemented by this improved computing tool. In particular, the improved computing tool of the illustrative embodiments specifically provides a locality-aware token management for a distributed file system. The improved computing tool implements mechanism and functionality, such as a locality-aware token manager, which cannot be practically performed by human beings either outside of, or with the assistance of, a technical environment, such as a mental process or the like. The computing tool provides a practical application of the methodology at least in that the computing tool is able to provide a hierarchy of token managers which enables local and global level token management that avoids the latency penalties of centralized token management systems.

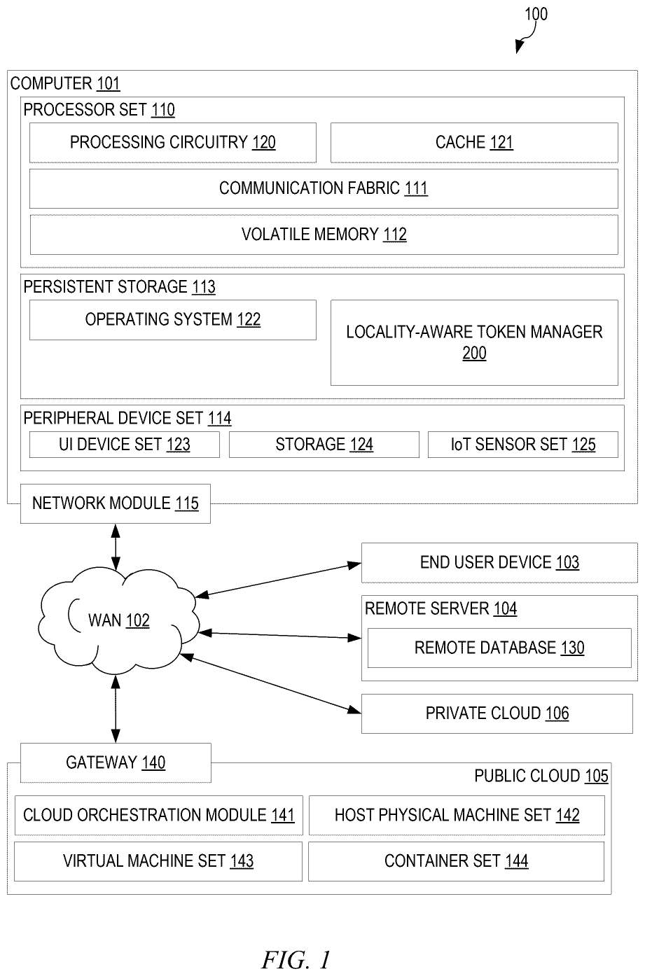

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as locality-aware token manager 200. In addition to locality-aware token manager 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and locality-aware token manager 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in locality-aware token manager 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in b locality-aware token manager 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a locality-aware token manager 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates locality-aware token management in a hierarchical manner between local token managers and one or more global token managers.

It should be appreciated that a plurality of the nodes, e.g., virtual and/or physical machines, in the distributed data processing system, may implement their own instance of a locality-aware token manager 200. Moreover, one or more nodes may implement a global locality-aware token manager. Each locality-aware token manager 200 may operate on behalf of a local cluster of nodes, whereas the one or more global locality-aware token manager operates on behalf of a plurality of localities, e.g., a region of local nodes, the entire distributed data processing system, or the like. Thus, on some nodes, the locality-aware token manager 200 is a local token manager, whereas in other nodes the locality-aware token manager 200 may operate as a global token manager. Other nodes may be only client nodes that do not implement a locality-aware token manager. Local instances of the locality-aware token manager 200 may be referred to herein as “local token managers” and global instances may be referred to as “global token managers.” It should be appreciated that local token managers may be remote to one another in a data network and may be remote to any global token managers.

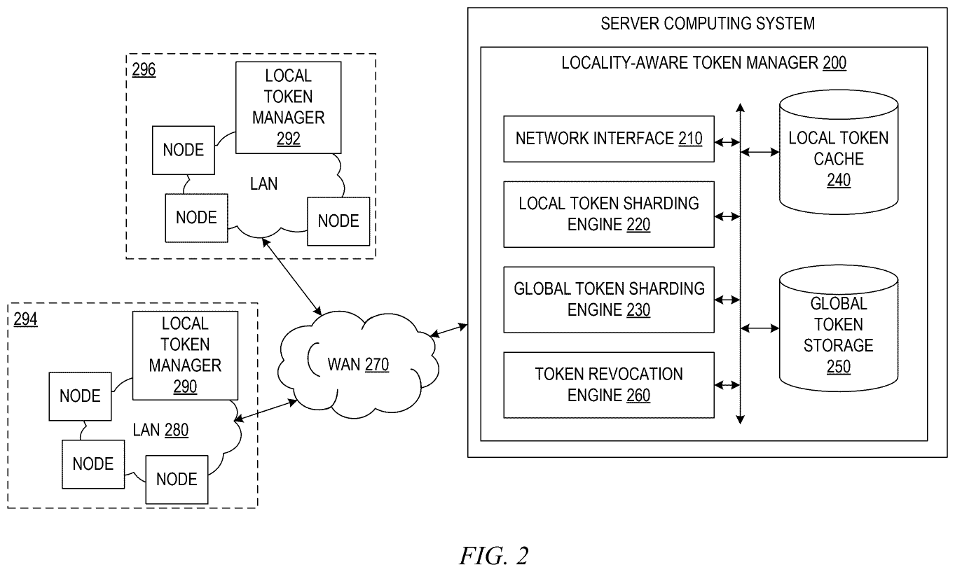

FIG. 2 is an example block diagram illustrating the primary operational components of a locality-aware token manager in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings and the resulting output may aid human beings. The invention is specifically directed to the automatically operating computer components directed to improving the way that accesses to computing resources using a token mechanism and strict consistency are performed so as to reduce latency, which cannot be practically performed by human beings as a mental process and is not directed to organizing any human activity.

As shown in FIG. 2, the locality-aware token manager 200 comprises a network interface 210, a local token sharding engine 220, a global token sharding engine 230, a local token cache 240, a global token storage 250, and a token revocation engine 260. The network interface 210 provides data communication logic for sending and receiving data via one or more data networks, e.g., wide area network (WAN) 270 and local area networks (LANs) 280. The data communication may be between token managers as discussed hereafter and may be specifically for managing sharded tokens associated with different token managers so as to be able to cache locally the tokens that are needed by local nodes to access resources.

As mentioned above, instances of the locality-aware token manager 200 may be designated local instances or global instances. A local instance of the locality-aware token manager 200, also referred to herein as a local token manager, operates on behalf of local nodes, where local is defined by the mechanism used to identify which nodes are within a given network topology range of each other, e.g., using latency or network address type identification of local/remote nodes. A global instance of the locality-aware token manager 200, also referred to herein as a global token manager, operates on behalf of the local token managers and manages tokens that are requested between local clusters of nodes associated with local token managers. For example, if a token is held by a first local token manager, and a node associated with a second local token manager is requesting the token, then the global token manager will handle the allocation and/or revocation of the token to service such a request, as described hereafter. Thus, while FIG. 2 shows the locality-aware token manager 200 having both local and global components, it should be appreciated that depending on the particular instance (e.g., local token manager or global token manager), one or more of the components may be not enabled or may be eliminated from the implementation of the locality-aware token manager 200 (e.g., if the instance is a local token manager, the global based components may be disabled). As can be seen from FIG. 2, local token managers (e.g., 290 and 292), may be local to their own cluster(s) of nodes (e.g., clusters 294 and 296, respectively) but may be remote from other local token managers.

The local token sharding engine 220 implements a local shard function on each token. Each token has a unique id and the local sharding engine converts that unique id to the identity of the local token manager which will store that node's cached tokens in the local token cache 240 for the local nodes. The local token cache 240 may store tokens granted by the global token manager (i.e., global instance of the locality-aware token manager 200) for files being used by local nodes as well as other information about the granting of the token including the types of access granted, the local nodes holding the token (i.e., the location of the token), and the like. The local shard function is a function that uses a unique identifier for an object protected by a token, such as in the case of a hash function or the like. For example, the i-node number of a file would be a unique identifier for the file and suitable as input to the shard function. Thus, for example, there may be a local token manager, such as local token manager 290, 292 for each locality of nodes 294, 296. Nodes of that locality 294 will look for tokens to access resources of that locality 294 using the local token manager 290. The local token manager 290 serves as a gateway to tokens that are not yet been cached locally by the local token manager 290 (e.g., tokens that have not yet been granted to a node or tokens held by other nodes of other localities 296).

New tokens are obtained by a local token manager via the global token sharding engine 230 using a different shard function, called a “global shard” function, which uniquely identifies a token manager from a global standpoint. As with the local shard function, the global shard function may also be a hash function or other function that uses a unique identifier for an object protected by a token (such as, for example, a file i-node number) for locating a local/global token manager for that token. The global shard function is used to locate a remote token manager (i.e., a local token manager which is remote from the requester's local token manager) that manages the token by requesting, from a global token manager, the token corresponding to the value generated by the global shard function. Thus, while the local shard function identifies the token's location at the local level, the global shard function identifies the token's location at a global level which spans multiple localities, e.g., local groups of nodes.

In requesting the new token from the global token manager, the local token manager indicates in the request from the local token manager to the global token manager that the requested new token is being requested only for caching the token and it is not the actual client node requesting the token in order to access a resource. This indicator may be provided, for example, as a “cache only” bit of the token, for example, which may be set to indicate whether the token is being cached only or not, where if this bit is not set, then the token is being used for read/write access to the corresponding resource.

In response to a request for a token from a local token manager, a global token manager checks its data storage if the token is in use and if not, it will grant both read and write access to the resources associated with the token. A global token storage 250 provides a data storage for tracking all tokens managed by that global token manager and identifies whether the token is in use for read/write, what use was granted with the token (e.g., read-only, write, read/write), and its location (nodes and local token managers that are using the resource protected by that token).

If there is a pending operation such as read or write then the token is given, then, once the operation is completed, the token no longer exists. If a global token manager determines that token is in use for read-only access, then it can be granted to a local token manager as a read-only token. The global token manager records granting the token to the local token manager in its token storage 250 and marks it to indicate a cache-only token. The local token manager can now grant the requested token to the original requester (i.e., the local node of the cluster associated with the local token manager) recording this granting of the requested token to the original requester in its token storage 240.

As cached tokens accumulate at the local token cache 240 of the local token manager, it has the ability to grant consistent tokens to any local node of the cluster(s) associated with that local token manager. For example, a local token manager 290 can grant tokens that are consistent with all tokens cached in the local token storage 240 to local nodes of the cluster 294. If the local token manager has read-write access, the local token manager can revoke tokens and grant tokens to other local nodes in the local cluster(s) without involving the global token manager. Likewise, if the local token manager has read-only access, the local token manager can grant read-only access to any local node without involving the global token manager.

In the case of a token conflict (e.g., a request to access a resource for which there is already a token granted to another node for conflicting access to the same object), the previously-granted token or tokens involved in the conflict need to be revoked, via the token revocation engine 260, from the nodes currently holding those tokens which are conflicting with the request. If the revoke operation comes to the local token manager from a non-local node (e.g., a node of another locality is requesting access to the resources and a global token manager determines that the token has been granted to another node and would need to be revoked), then the token revocation engine 260 of the local token manager will propagate the revocation to the local nodes holding conflicting tokens by identifying these local nodes via the local token cache 240. In a like manner, if a local node requests a conflicting token, the local token manager passes the revoke operation to the remote token manager, via the global token manager, and waits for the remote token manager's reply before granting the token locally. For example, if a node in cluster 294 requests a token to write to a file whose token is currently managed by a local token manager 292 in cluster 296, then the local token manager 290 will send the revocation operation request to the remotely located token manager 292 and await a reply indicating that the remotely located token manager 292 has completed revocation of the token in its local cluster 296.

As noted above, a “cache-only” token bit in the actual token structure is used to manage the token and is used by the global token manager for recovery. When a node fails, the global token manager detects the failure through known cluster membership protocols and frees all tokens held by that node. If a local token manager fails, the surviving nodes elect a new node to become the local token manager and inform it of all tokens currently held.

In accordance with one or more of the illustrative embodiments, for locality-aware token managers 200, it is important to know which recovery method should be applied for each token. If the “cache-only” token bit is not set in the tokens, then the tokens belonging to the failed node are freed. If the “cache-only” token bit is set, then the global token manager waits for local token manager recovery to complete. The global token manager, in this case, does not free the tokens but reassigns the token ownership to the new local token manager. Similarly, if the number of local token managers changes (for example, by adding or deleting local token managers), the tokens can be shuffled between the local token managers without involving the global token manager(s). If a global token manager attempts to revoke a locally held token, it must wait for the local shuffling to complete, but all other token managers remain unaffected.

As noted above, while the illustrative embodiments employ a hierarchy of token managers in which there are two-levels (i.e., global and local), the present disclosure is not limited to such. Rather, any number of levels of hierarchy of token managers may be employed without departing from the spirit and scope of the present disclosure. In illustrative embodiments where more than two levels of hierarchy are implemented, additional different shard functions may be utilized at each level to map the token ids to different subsets of nodes or localities. Thus, a fine grain partitioning of the token space may be implemented to provide parallel token management and limit its impact under failures. In the case of singleton nodes which have no local neighbors, these nodes can use the global shard function for all tokens.

Thus, the illustrative embodiments provide a computing tool and computing tool operations/functionality for token management that implements a multi-level hierarchy of token managers. The hierarchy level based token sharding mechanisms and local token manager based granting of tokens to local nodes avoids the bottlenecks associated with nodes having to obtain tokens to access resources. The local token manager caching tokens for local nodes minimizes the need to access tokens from remote locations to access local resources; for example, a local node needing to access a copy of a local file does not need to access a global token manager if the local token manager has already cached the token locally. This increases the speed of access of computing resources and reduces data traffic across data networks 270, 280. This, in turn, increases application performance by reducing latency because nodes will not have to wait as long to get tokens for accessing resources due to the local caching of these tokens by the local token managers 290, 292.

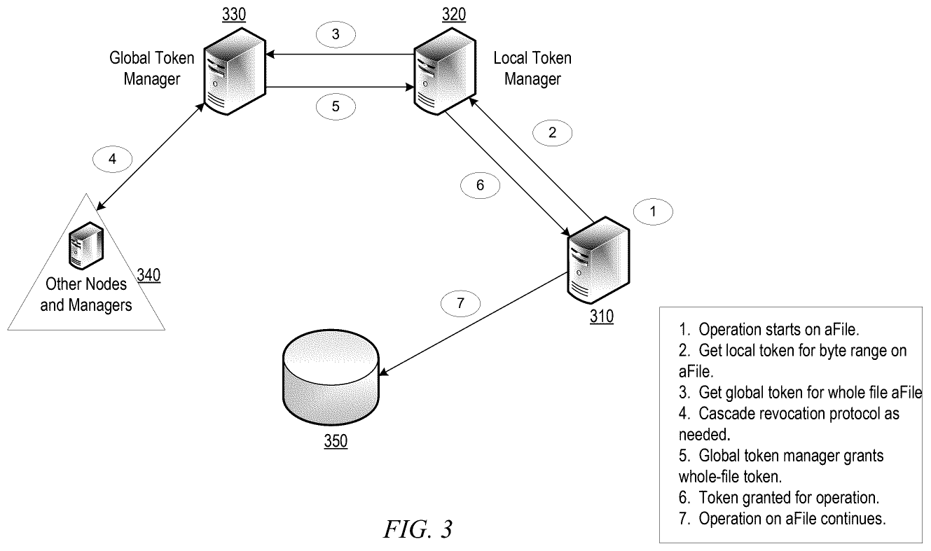

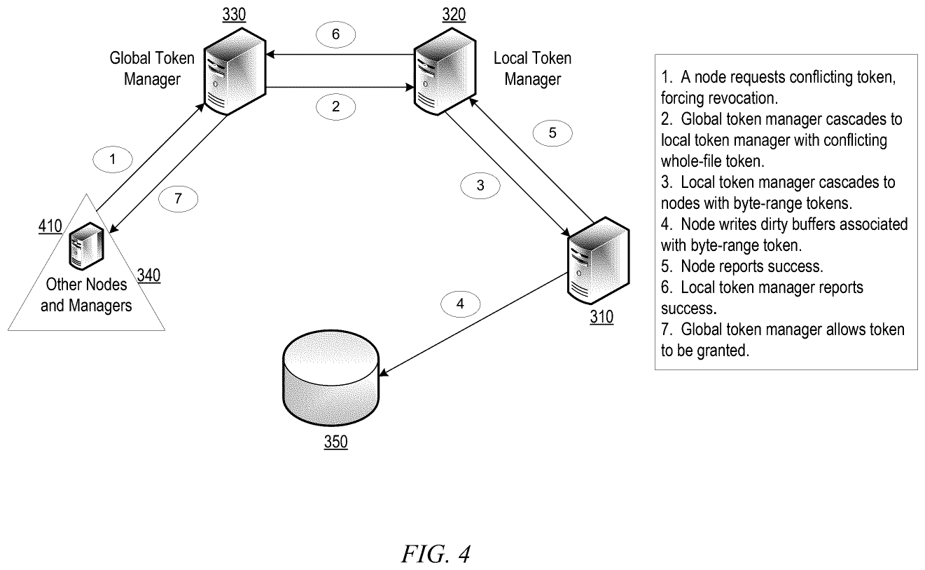

To further illustrate an example operation of the present invention, FIGS. 3 and 4 are provided as examples of how a node may gain access to a local file when the token for that file is held by a remotely located token manager. FIG. 3 is an example diagram illustrating an example locality-aware token request processing operation in accordance with one illustrative embodiment. FIG. 4 is an example diagram illustrating an example locality-aware token revocation operation in accordance with one illustrative embodiment.

With reference now to FIG. 3, the operation starts with a node 310 requesting to access a file (operation 1); for example, the node 310 may be a workstation, client computing device, server, or the like, and the node 310 may request to access the file to read and/or write to the file. The local token manager 320 gets the local token for the byte range of the file (operation 2), where the byte range is a subset of a file (e.g., update of a range of content from an existing file). If the token is currently in the local token manager's local token cache, then the token may be granted by the local token manager 320 to the node 310 (operation 6) and the node 310 may then perform its requested operation on the file in the data storage 350 (operation 7). However, if the token is not currently in the local token cache of the local token manager 320, then the local token manager requests the global token for the whole file from the global token manager 330 (operation 3). If the global token manager 330 has to revoke the requested token from a node that holds the token, then the global token manager 330 may cascade the revocation as needed to the other nodes and token managers 340 (operation 4). Once the revocation is complete and the token is available at the global token manager 330, the global token manager grants the whole file token to the local token manager 320 (operation 5).

The local token manager 320 caches the whole file token in the local token cache and may then grant the token to the original requester, i.e., node 310 (operation 6). The local node 310 may then perform its access operation on the file (operation 7). Thereafter, if the same or another local node requests access to the same file, then the token is stored locally in the local token cache of the local token manager 320 and, thus, does not need to communicate with the global token manager 330 to grant the token to the local node.

With reference now to FIG. 4, the operation starts with a node 410 requesting a conflicting token which forces a revocation operation by the global token manager 330 (operation 1). The global token manager 330 cascades the revocation operation to the local token manager 320 that is holding the conflicting whole-file token (operation 2). The local token manager 320 cascades the revocation operation to the local node(s) 310 with the local byte-range tokens (operation 3). The local node(s) 310 writes dirty operating system file buffers (buffers that were written to but not yet committed to permanent storage) associated with the byte-range token to permanent storage (operation 4). The local node(s) 310 report success (operation 5) and the local token manager 320 reports success back to the global token manager 330 (operation 6). The global token manager then allows the token to be granted to the requester 410 (operation 7).

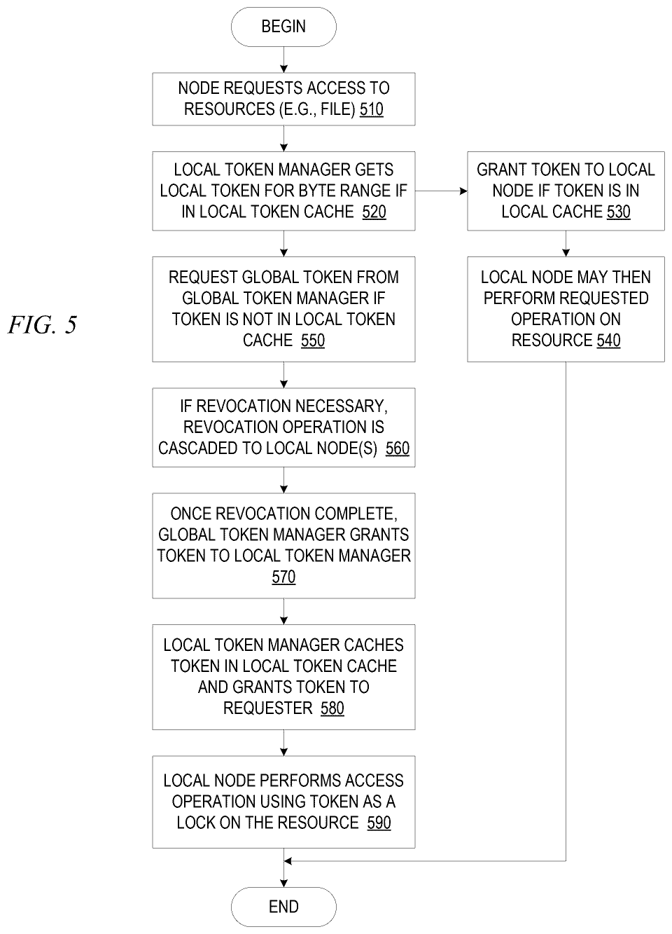

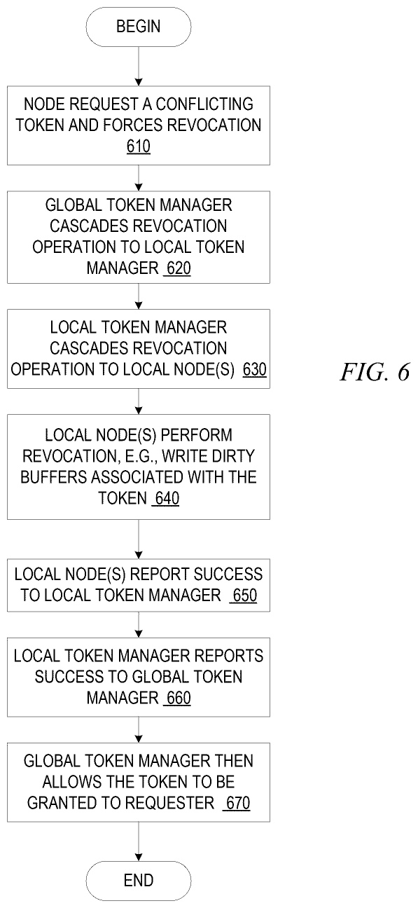

These operations are also reflected in the flowcharts of FIGS. 5 and 6. That is, FIGS. 5 and 6 present flowcharts outlining example operations of elements of the present invention with regard to one or more illustrative embodiments. It should be appreciated that the operations outlined in FIGS. 5 and 6 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 5 and 6, and may, in some cases, make use of the results generated as a consequence of the operations set forth in FIGS. 5 and 6, the operations in FIGS. 5 and 6 themselves are specifically performed by the improved computing tool in an automated manner.

FIG. 5 is a flowchart outlining an example locality-aware token request processing operation in accordance with one illustrative embodiment. As shown in FIG. 5, the operation starts with a node requesting access to a resource (step 510). The local token manager gets the local token for the byte range of the file if it is available in the local token cache (step 520). If the token is currently in the local token manager's local token cache, then the token may be granted by the local token manager to the local node (step 530) and the local node may then perform its requested operation on the resource, e.g., read, write, read/write (step 540). However, if the token is not currently in the local token cache of the local token manager, then the local token manager requests the global token for the whole file from the global token manager (step 550). If the global token manager has to revoke the requested token from a node that holds the token, then the global token manager may cascade the revocation as needed to the other nodes and token managers (step 560).

Once the revocation is complete and the token is available at the global token manager, the global token manager grants the whole file token to the local token manager (step 570). The local token manager caches the whole file token in the local token cache and may then grant the token to the original requester (step 580). The local node may then perform its access operation on the file (step 590). The operation then terminates.

FIG. 6 is a flowchart outlining an example locality-aware token revocation operation in accordance with one illustrative embodiment. As shown in FIG. 6, the operation starts with a node requesting a conflicting token which forces a revocation operation by the global token manager (step 610). The global token manager cascades the revocation operation to the local token manager that is holding the conflicting whole-file token (step 620). The local token manager cascades the revocation operation to the local node(s) with the local byte-range tokens (step 630). The local node(s) writes dirty buffers associated with the byte-range token (step 640). The local node(s) report success (step 650) and the local token manager reports success back to the global token manager (step 660). The global token manager then allows the token to be granted to the requester (step 670). The operation then terminates.

The description of the present invention has been presented for purposes of illustration and description and is not intended to be exhaustive or limited to the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application and/or technical improvement over technologies found in the marketplace, and/or to enable others of ordinary skill in the art to understand the embodiments disclosed herein.

What is claimed is:

1. A method in a data processing system for controlling access to computing resources, the method comprising:
receiving, at a first local token manager, a request for a token to access a computing resource from a local node associated with the first local token manager;
determining, at the first local token manager, if the token is present in a local token cache of the first local token manager;
in response to the token being present in the local token cache, granting, by the first local token manager, the token to the local node;
in response to the token not being present in the local token cache, requesting the token from a global token manager; and
in response to receiving the token from the global token manager, caching the token in the local token cache of the first local token manager and granting the token to the local node.

2. The method of claim 1, further comprising:
configuring a plurality of nodes into a plurality of clusters of nodes, wherein nodes of a same cluster are local nodes of the corresponding cluster; and
configuring at least one node of each cluster in the plurality of clusters to provide a corresponding local token manager to manage tokens for the cluster to thereby generate one or more local token managers, wherein the first local token manager is one of the one or more local token managers; and
configuring at least one node of the plurality of nodes to provide the global token manager.

3. The method of claim 2, wherein, for each cluster in the plurality of clusters, nodes of the cluster only communicate with a corresponding local token manager of the cluster to obtain tokens for accessing computer resources of a distributed file system, and wherein the local token managers in the one or more local token managers communicate with the global token manager to obtain tokens that they do not already have cached in their local token cache.

4. The method of claim 2, wherein configurating the plurality of nodes into a plurality of clusters of nodes comprises enabling a location awareness capability of the nodes in the plurality of nodes to determine which other nodes are local to each other.

5. The method of claim 4, wherein the location awareness capability comprises at least one of pinging nodes to determine latency and identifying local nodes whose latency is below a given threshold or analyzing network addresses to determine which nodes are local based on subnet identifiers.

6. The method of claim 2, further comprising generating a local shard function for allocating different shards of a set of tokens to be assigned to each of the local token managers, wherein a shard associated with a given local token manager has only token identifiers of computing resources in a portion of a distributed file system that are local to the given local token manager.

7. The method of claim 6, further comprising generating a global shard function, different from the local shard function, that locates a remotely located local token manager that manages a token.

8. The method of claim 1, wherein requesting the token from the global token manager comprises:
the first local token manager sending a request to the global token manager for a token to access the computing resource;
the global token manager determining if the token to access the computing resource is free or in use, and, if the token is in use, if the use is read-only use; and
in response to the token being free or in use for read-only use, the global token manager granting the token to the local token manager specifying the token is a cache-only token, wherein the token is stored in a local cache of the local token manager with a cache-only bit set.

9. The method of claim 8, further comprising, in response to the global token manager determining that a token conflict exists in response to receiving the request, propagating a revocation of the token from a node holding the token before granting the token to the local token manager.

10. The method of claim 8, wherein in response to a local token manager of a cluster failing, a new local token manager for the cluster identifies which tokens are held by the failed local token manager and determines if the cache-only bit is set for the identified tokens, and for first tokens which do not have the cache-only bit set, the first tokens are freed, and for second tokens that do not have the cache-only bit set, after recovery of the new local token manager is complete, token ownership of the second tokens is set to the new local token manager.

11. A computer program product comprising a computer readable storage medium having a computer readable program stored therein, wherein the computer readable program, when executed in a data processing system, causes the data processing system to:
receive, at a first local token manager, a request for a token to access a computing resource from a local node associated with the first local token manager;
determine, at the first local token manager, if the token is present in a local token cache of the first local token manager;
grant, in response to the token being present in the local token cache, by the first local token manager, the token to the local node;
request, in response to the token not being present in the local token cache, the token from a global token manager; and
cache, in response to receiving the token from the global token manager, the token in the local token cache of the first local token manager and granting the token to the local node.

12. The computer program product of claim 11, wherein the computer readable program further causes the data processing system to:
configure a plurality of nodes into a plurality of clusters of nodes, wherein nodes of a same cluster are local nodes of the corresponding cluster; and
configure at least one node of each cluster, in the plurality of clusters, to provide a corresponding local token manager to manage tokens for the cluster to thereby generate one or more local token managers, wherein the first local token manager is one of the one or more local token managers; and
configure at least one node, of the plurality of nodes, to provide the global token manager.

13. The computer program product of claim 12, wherein, for each cluster in the plurality of clusters, nodes of the cluster only communicate with a corresponding local token manager of the cluster to obtain tokens for accessing computing resources of a distributed file system, and wherein the local token managers in the one or more local token managers communicate with the global token manager to obtain tokens that they do not already have cached in their local token cache.

14. The computer program product of claim 12, wherein configurating the plurality of nodes into a plurality of clusters of nodes comprises enabling a location awareness capability of the nodes in the plurality of nodes to determine which other nodes are local to each other.

15. The computer program product of claim 14, wherein the location awareness capability comprises at least one of pinging nodes to determine latency and identifying local nodes whose latency is below a given threshold or analyzing network addresses to determine which nodes are local based on subnet identifiers.

16. The computer program product of claim 12, wherein the computer readable program further causes the data processing system to generate a local shard function for allocating different shards of a set of tokens to be assigned to each of the local token managers, wherein a shard associated with a given local token manager has only token identifiers of computing resources in a portion of a distributed file system that are local to the given local token manager.

17. The computer program product of claim 16, wherein the computer readable program further causes the data processing system to generate a global shard function, different from the local shard function, that locates a remotely located local token manager that manages a token.

18. The computer program product of claim 11, wherein the request for the token from the global token manager comprises:
the first local token manager sending a request to the global token manager for a token to access the computing resource;
the global token manager determining if the token to access the computing resource is free or in use, and if the token is in use, if the use is read-only use; and
in response to the token being free or in use for read-only use, the global token manager granting the token to the local token manager specifying the token is a cache-only token, wherein the token is stored in a local cache of the local token manager with a cache-only bit set.

19. The computer program product of claim 18, further comprising, in response to the global token manager determining that a token conflict exists in response to receiving the request, propagating a revocation of the token from a node holding the token before granting the token to the local token manager.

20. An apparatus comprising:
at least one processor; and
at least one memory coupled to the at least one processor, wherein the at least one memory comprises instructions which, when executed by the at least one processor, cause the at least one processor to:
receive, at a first local token manager, a request for a token to access a computing resource from a local node associated with the first local token manager;
determine, at the first local token manager, if the token is present in a local token cache of the first local token manager;
grant, in response to the token being present in the local token cache, by the first local token manager, the token to the local node;
request, in response to the token not being present in the local token cache, the token from a global token manager; and
cache, in response to receiving the token from the global token manager, the token in the local token cache of the first local token manager and granting the token to the local node.
